(19) United States
(12) Patent Application Publication
(10) Pub. No.: US 2005/0071084 A1
(43) Pub. Date: Mar. 31, 2005

(54) Method and device for the predictive regulation of the dynamics of vehicle movement regarding the tracking stability and stabilizing of a vehicle

(76) Inventors: Michael Knoop, Ludwigsburg (DE); Michael Weilkes, Sachsenheim (DE); Fred Oechsle, Ludwigsburg (DE)

Correspondence Address: KENYON & KENYON, ONE BROADWAY, NEW YORK, NY, 10004, US

(21) Appl. No.: 10/502,968

(22) PCT Filed: Dec. 7, 2002
(86) PCT No.: PCT/DE02/04488

(30) Foreign Application Priority Data
Jan. 30, 2002 (DE) 10203499.0

(51) Int. Cl. G01S 1/00

(52) U.S. Cl. 701/301; 340/436

(57) ABSTRACT

A method for influencing a system that controls or regulates the position and/or the orientation of a motor vehicle with respect to a traffic lane is provided. The system is deactivated if a danger of collision with an obstacle in the traffic lane is detected, and that the system is activated only if a potentially dangerous situation with respect to the driving dynamics of the motor vehicle is detected.

### FIELD OF THE INVENTION

The present invention relates to a method and a device for influencing a system that controls or regulates the position and/or the orientation of a motor vehicle with respect to a traffic lane.

### BACKGROUND INFORMATION

The introduction of video sensors, which record the vehicle environment, makes possible new systems of active safety. Among these are systems which record the course of the traffic lane ahead of the vehicle and, when it threatens to run off the traffic lane, the systems undertake interventions in the movement of the vehicle.

German Published Patent Application No. 199 16 267 describes a method and a device for monitoring or for influencing a vehicle on a path. In this context, the method ascertains a setpoint value and an actual movement of the vehicle, executes a comparison of the setpoint path and the actual movement, and haptically transmits to the driver of the vehicle an information variable according to the comparing result, or at least controls a wheel brake according to the result of the comparison.

### SUMMARY OF THE INVENTION

In today's driving stabilization systems, the driver has to perform the tracking by specifying the steering angle, even in critical situations in which many drivers have too many demands made on them. The method of the present invention supports the driver, especially in critical situations with respect to driving dynamics, by tracking which is activated, for instance, during an intervention of a vehicle dynamics control system (e.g. ESP=“electronic stability program”, FDR=“Fahrdynamikregelung” (vehicle dynamics regulation)). The method of the present invention works autonomously in the vehicle, based on video-based tracking recording. It does not require a digital map, and therefore it does not have to be updated. Furthermore, the system of the present invention need not be supported by devices in the infrastructure.

The present invention provides a method for influencing a system that controls or regulates the position and/or orientation of a motor vehicle with respect to a traffic lane (=tracking system, often denoted as a “lane-keeping system”). In this context, more important than the construction and the operating mode of the tracking system, is the control of such a system. This control of the tracking system manifests itself in that activation and deactivation of this system occurs as a function of variables of both the vehicle and the surroundings.

In a first exemplary embodiment, the tracking system according to the present invention is activated when the danger of a collision of the motor vehicle with an obstacle in the traffic lane is detected. In response to a detected obstacle in the traffic lane, a possible collision of an obstacle and the vehicle is able to be avoided by deactivating tracking.

The configuration of the first exemplary embodiment of the present invention is characterized in that the system is deactivated even if no potentially dangerous situation with respect to the driving dynamics of the motor vehicle is detected, or if clear indications are detected that the driver of the motor vehicle wants to leave the traffic lane. These deactivations provide that, in the case of driving situations recognized as not being dangerous and in the case of the detected driver command after leaving the traffic lane, there is no “making up the mind” of the driver by the tracking system. In these cases, tracking remains the task of the driver.

In a second exemplary embodiment, the tracking system is only activated when a potentially dangerous situation with respect to the driving dynamics of the motor vehicle is detected.

In an exemplary embodiment of the present invention, the tracking system is activated only if, in addition, no danger of collision of the motor vehicle with an obstacle on the traffic lane is detected, and if no clear indications are detected that the driver of the motor vehicle wants to leave the traffic lane.

A third exemplary embodiment provides that the tracking system is deactivated if a danger of a collision with an obstacle in the traffic lane is detected, and the tracking system is only activated if a potentially dangerous situation with respect to the driving dynamics of the motor vehicle is detected.

An exemplary embodiment of the present invention provides that the tracking system is deactivated even if no potentially dangerous situation with respect to the driving dynamics of the motor vehicle is detected, or if clear indications are detected that the driver of the motor vehicle wants to leave the traffic lane, and the tracking system is only activated if, in addition to the detection of a potentially dangerous situation for the driving dynamics, no danger of a collision of the motor vehicle with an obstacle on the traffic lane is detected, and no clear indications are detected that the driver of the motor vehicle wants to leave the traffic lane.

In the detection of a danger of a collision with an obstacle, the present invention provides that variables describing the geometrical course of the traffic lane, variables describing the movement of the vehicle, as well as obstacles recorded by a video system and/or a radar system, serve as an input. This provides a qualitative recording of the danger of a collision.

In addition, the present invention provides that the detection of a potentially dangerous situation with respect to the driving dynamics occurs by evaluation of variables describing the vehicle movement, and/or by the determination of whether regulating interventions influencing the driving dynamics are being performed by a driving stabilization system present in the vehicle.

Since an increasing number of vehicles are equipped with a driving stabilization system or a vehicle dynamics control system, one may therefore fall back on the sensor system of the driving stabilization system or the vehicle dynamics control system.

The present invention provides that a clear indication that the driver of the vehicle wants to leave the traffic lane is when a direction indicator is being operated by the driver or when the steering wheel angular velocity exceeds a predefinable threshold value.

Both the ascertainment of the state of the travel direction indicator and the ascertainment of the steering wheel angular velocity may be achieved using little expenditure.

The orientation of the vehicle may be determined with respect to a travel lane by the angle between the lane tangent and the longitudinal axis of the vehicle.

The system controlling or regulating the position and/or the orientation of a motor vehicle with respect to a lane may be a system autonomous to the vehicle. In this case, one is not dependent upon any external infrastructure for its operation.

### BRIEF DESCRIPTION OF THE DRAWINGS

FIG. 1 shows an example embodiment of a method of the present invention in the form of a block diagram.

FIG. 2 shows the influencing possibilities of the tracking system in the form of a linkage table.

FIG. 3 shows the structure of an example embodiment of the present invention in the form of a block diagram.

### DETAILED DESCRIPTION

The system of the present invention includes a device working autonomously to the vehicle for recording the following variables:

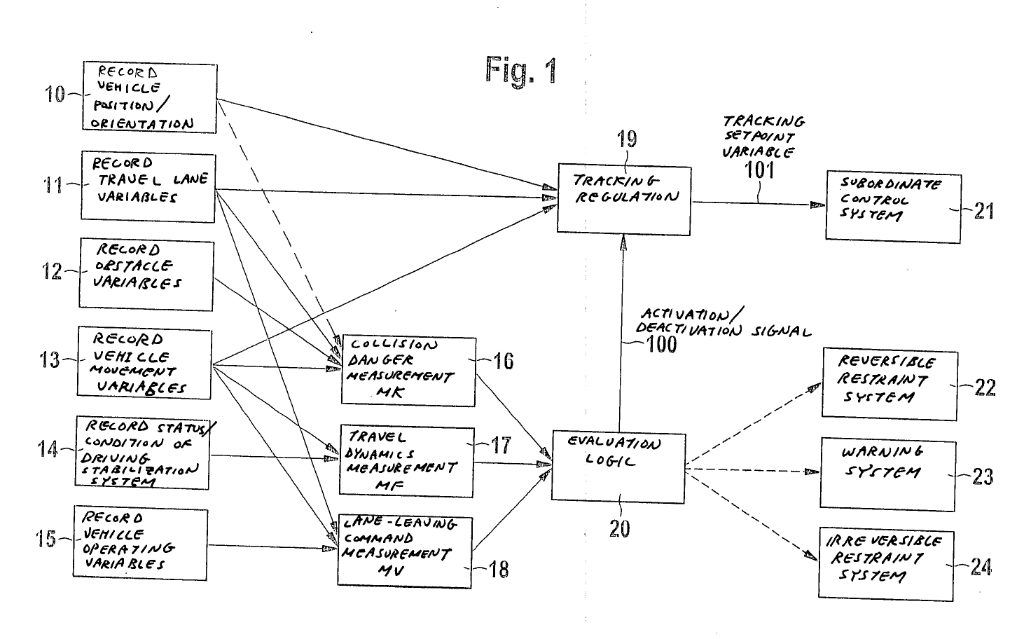

1. Recording travel lane variables and the course of the travel lane. This includes the determination of, for instance, the width, the curvature or the change in curvature of the travel lane. This may also include the recording of the existence of additional lanes or the recording of roadway markings (e.g. of the center line of the roadway). This is shown in block 11 of FIG. 1.

2. Recording of the vehicle position and the vehicle orientation relative to the lane. It includes, for instance, the recording of the lateral deviation of the vehicle (lateral deviation=lateral displacement from the middle of the lane) and the recording of the angle between the travel lane tangent and the longitudinal axis of the vehicle. This is shown in block 10 of FIG. 1.

3. The recording of obstacles, such as other vehicles or objects or living beings located on the roadway. Recorded variables are, for example, the longitudinal distance from the obstacle, the lateral deviation with respect to the obstacle or the relative speed. This is shown in block 12 of FIG. 1.

The recording of these variables may, for instance, be done by video sensor and a postconnected evaluation unit. For the recording of obstacles, in addition to the video sensor, a radar sensor may also be used. The data from each sensor are then brought together by sensor data aggregation.

In addition to the above, the following additional variables are recorded.

4. Recording of vehicle movement variables. Variables such as the vehicle's longitudinal speed, the yaw rate of the vehicle and the transverse acceleration are recorded. (Block 13, FIG. 1).

5. Recording of the status or the operating condition of a driving stabilization system. This includes, for example, the recording of the status of status flags of a vehicle dynamics control. A status flag of a vehicle dynamics control may indicate, for example, whether the vehicle dynamics controller is in an active mode (block 14, FIG. 1).

6. Recording of vehicle operating variables. This includes, for example, the recording of an activation of a travel direction indicator or the recording of the steering wheel angular speed (block 15, FIG. 1).

From the vehicle movement variables (block 13, FIG. 1) and/or the status flags of a vehicle dynamics control (block 14, FIG. 1) a measurement is formed in block 17 in FIG. 1 for the dynamics of the travel state. This measurement denoted as travel dynamics measurement MF influences, besides other (later explained) measurements, the activation or deactivation of a tracking regulation.

Furthermore, from the vehicle operating variables (block 15, FIG. 1) and possibly also from the vehicle movement variables (block 13, FIG. 1) as well as from the lane variables (block 11, FIG. 1), in block 18 in FIG. 1, a measurement is calculated for the command of the driver after leaving the lane. This lane-leaving command measurement MV is used for preventing a tracking intervention when the driver wishes to leave the lane, such as for turning off the road. Into the lane-leaving command measurement, data from systems for recording traffic lights and/or recording traffic signs may also be input. This makes sense, because at traffic lights or crossings one must increasingly count on turning off procedures. In the same manner, into the lane-leaving command measurement, there may also be input data about the existence of crossings or roads ahead of the vehicle, which will possibly be made available by future lane recording systems. For the evaluation of potential danger while leaving the lane, data about the existence of additional lanes may be consulted. For example, tracking interventions may be blocked or activated later when the vehicle leaves to the right of the lane and when an additional lane exists to the right.

In addition, a collision danger measurement MK is ascertained, in block 16 in FIG. 1, from the ascertained lane variables (block 11, FIG. 1), the recorded obstacles ahead of the vehicle (block 12, FIG. 1), the ascertained vehicle movement variables (block 13, FIG. 1), as well as optionally the ascertained vehicle position and vehicle orientation relative to the lane (block 10, FIG. 1). If a collision with an obstacle is imminent in one's own lane, the tracking interventions are also forestalled, since driver will likely wish to avoid the collision by “flight from the road”.

In the following, the three ascertained measurements are once more summarized in abbreviated form:
collision danger measurement MK. A high value of MK means a great danger of collision.
driving dynamics measurement MF. A high value of MF means a situation that is potentially dangerous from a driving dynamics point of view.
the lane-leaving command measurement MV. The greater the value of the lane-leaving command measurement, the greater the indication that the driver deliberately wants to leave the lane.

Tracking regulation 19 processes the position and the angular orientation of the vehicle relative to the travel lane (block 10, FIG. 1). Furthermore, the tracking regulation processes the travel lane variables (block 11, FIG. 1) and the vehicle movement variables (block 13, FIG. 1). From these variables a setpoint variable is ascertained (setpoint variable 101 in FIG. 1), which acts upon a subordinate control system (block 21, FIG. 1). The setpoint variable is calculated in such a manner that the vehicle is held in its lane, in addition to the stabilization undertaken in any case by the driving stabilization system. Several setpoint variables may, of course, also be calculated. Suitable setpoint variables are, for example, the setpoint yaw rate, the setpoint steering angle, the setpoint steering torque or the setpoint transverse speed. As subordinate control systems for these, the following come into consideration:

1. The yaw rate regulation of a vehicle dynamics control system (ESP system, FDR system) which, on its part, triggers wheel-selective braking interventions in order to correct the actual yaw rate of the vehicle to the setpoint yaw rate.

2. The steering angle regulation of an active steering system.

3. The steering torque regulation of an active steering system.

4. The yaw rate regulation of an active steering system which, on its part, triggers steering angle or steering torque interventions, in order to correct the actual yaw rate of the vehicle to the setpoint yaw rate.

5. The yaw rate regulation of a system for the combined regulation of several chassis systems which, on its part, triggers wheel-selective braking interventions, steering angle interventions or interventions in normal force actuators (e.g. active spring or damper elements, active stabilizers), in order to correct the actual yaw rate of the vehicle to the setpoint yaw rate.

6. The transverse speed regulation of a vehicle dynamics control system, of an active steering system or a composite regulating system which, on its part, undertakes interventions in the vehicle movement, in order to correct the actual transverse speed to the setpoint transverse speed.

Tracking regulation is activated when the following conditions are simultaneously satisfied:

1. The travel situation is critical from a driving dynamics point of view, i.e., driving dynamics measurement MF exceeds a boundary GF1.

2. The lane-leaving command measurement MV undershoots a boundary GV1.

3. The collision danger measurement MK undershoots a boundary GK1.

Tracking regulation is deactivated if:

1. driving dynamics measurement MF undershoots a boundary GF2; or

2. lane-leaving command measurement MV exceeds a boundary GV2; or

3. collision danger measurement MK exceeds a boundary GK2.

In the deactivation, a sliding transition of the tracking setpoint variable (signal 101 in FIG. 1) into the passive state may be performed, in order to avoid irregular (jerky) changes of the interventions in the vehicle movement.

As a run-up to an intervention in the vehicle movement, further measurements may be performed (possibly having lower boundaries for the driving dynamics measurement and higher boundaries for the lane-leaving command measurement). These are, for example:

1. the triggering of reversible restraint systems (e.g. seat belt tensioners) in block 22, FIG. 1,

2. the change in the triggering thresholds of irreversible restraint systems (such as an air bag) in block 24, FIG. 1,

3. the triggering of signaling means (e.g. warning blinkers) for warning other traffic participants in block 23, FIG. 1.

FIG. 1 shows:
In block 10, the vehicle position is recorded within the lane.
In block 11, lane variables are recorded.
In block 12, an object list of obstacles ahead of the vehicle is set up.
The vehicle movement variables are recorded in block 13.
Block 14 ascertains the status of driving stabilization systems.
Block 15 ascertains vehicle operating variables.

From the results of function blocks 10 to 15, the following three variables are now derived:

1. In block 16, the danger of a collision with obstacles is ascertained. Block 16 receives its input signals from block 11 (lane variables), from block 12 (obstacles), from block 13 (vehicle movement variables), as well as optionally from block 10.

2. In block 17, the danger of the current driving dynamics status is ascertained. This is ascertained from the vehicle movement variables in block 13 and the ascertained status of the vehicle stabilization system in block 14.

3. In block 18, indicators for a possible command of the driver for leaving the lane are ascertained. As input variables, the lane variables ascertained in block 11, the vehicle movement variables ascertained in block 13 and the vehicle operating variables ascertained in block 15 are used.

In this context, the possibility exists of also recording the results of blocks 16, 17 and 18 quantitatively. The collision danger of obstacles (in block 16) is recorded by a collision endangerment measurement MK. In block 17, a driving dynamics measurement MF is set up, and in block 18 a lane-leaving command measurement MV is set up. These measuring numbers are able to be evaluated, and also, for example, compared to threshold values. The results of these evaluations in blocks 16, 17, 18 go into evaluation logic 20 as input signals. Evaluation logic 20 makes a decision regarding an activation or a deactivation of tracking regulation 19. The activating and deactivating signals are denoted in FIG. 1 by the number 100. The tracking regulation receives its input signals from block 10 (the vehicle's position in the lane), from block 11 (these are the lane variables) and from block 13 (the vehicle movement variables). Setpoint variables 101 are calculated by tracking regulation 19, and they are passed on to a subordinate controlling system 21. Besides activating and deactivating tracking regulation 19, evaluation logic 20 fulfills an additional purpose. Reversible restraint systems 22 may be activated by this evaluation logic, warning systems 23 may be activated and irreversible restraint systems 24 may be activated.

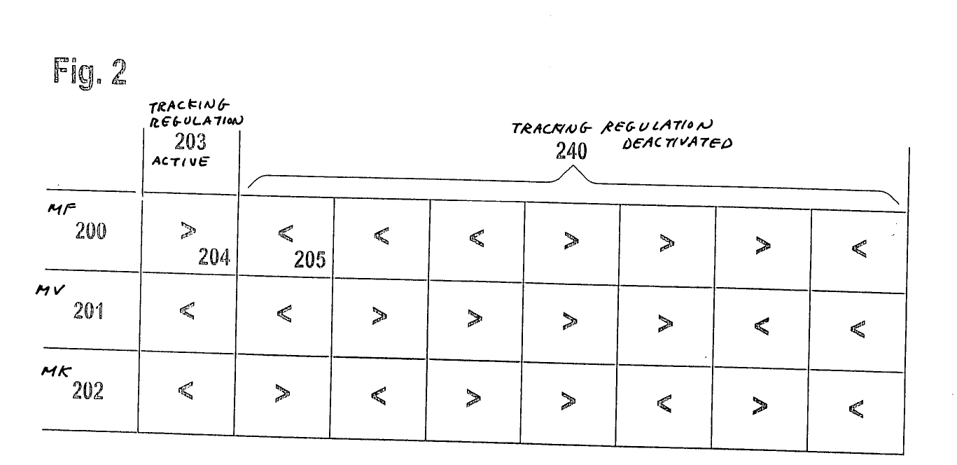

FIG. 2 shows a two-dimensional matrix. In the vertical direction, from top left to bottom, driving dynamics measurement MF is shown as line 200, lane-leaving command measurement MV is shown as line 201 and collision danger measurement MK is shown as line 202. In the horizontal direction, the number 203 (above the left column) means that the tracking regulation has been activated. The number 240 (above the seven right columns) means that the tracking regulation has been deactivated.

In this matrix the symbols > and < are to be found. In this context, in the field marked 204, the symbol > means, for example, that driving dynamics measurement MF exceeds a boundary GF1. In field 205, the symbol < means that the driving dynamics measurement MF undershoots a boundary GF1. With that, in this matrix all 8=2 * 2 * 2 possible combinations are included, namely that the driving dynamics measurement MF is able to exceed or undershoot a boundary value (2 possibilities), that the lane-leaving command measurement MV is able to exceed or undershoot a boundary value (2 possibilities), and that the collision danger measurement MK is able to exceed or undershoot a boundary value (2 possibilities).

It is possible to select, for each of these measurements, various boundary values with respect to exceeding or undershooting. This will be described now in connection with driving dynamics measurement MF.

It is assumed here that collision danger measurement MK and lane-leaving command measurement MV are very small, i.e., there is a small collision danger and there are no strong indications for a lane change command by the driver. Now, if the driving dynamics measurement exceeds a first boundary GF1, the tracking regulation is activated. However, deactivating the tracking regulation occurs only after the driving dynamics measurement undershoots a boundary GF2. In this context, it is possible to select different values for GF1 and GF2. In this manner a hysteresis behavior is brought about.

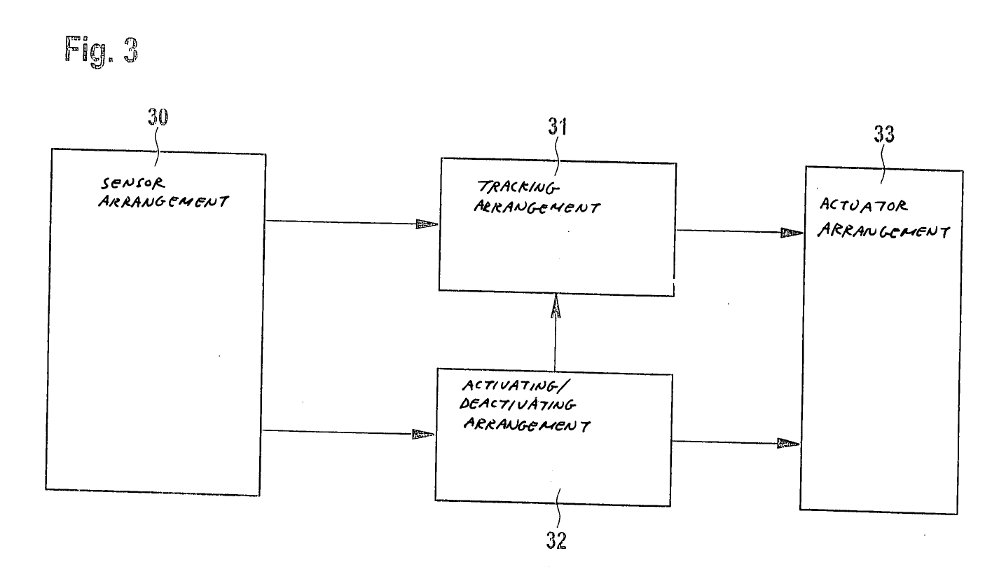

Finally, FIG. 3 shows:
sensor arrangement is included in block 30,
tracking arrangement is included in block 31,
activating arrangement and deactivating arrangement are included in block 32 and
actuator arrangement are included in block 33.

The output signals of block 30 are supplied to blocks 31 and 32. The output signals of block 32 are supplied to blocks 31 and 33. The output signals of block 31 are supplied to block 33. Sensor arrangement 30 records the vehicle's position and orientation within the lane (see block 10, FIG. 1), the lane variables (see block 11, FIG. 1), obstacles ahead of the vehicle (see block 12, FIG. 1), vehicle movement variables (see block 13, FIG. 1), the status of vehicle stabilization systems (see block 14, FIG. 1), as well as vehicle operating variables (see block 15, FIG. 1). The output signals of the sensor arrangement are supplied to tracking arrangement 31, which is responsible for an automatic tracking of the vehicle (e.g., responsible for the vehicle's traveling always in the middle of the correct lane), and to activating and deactivating arrangement 32, by which tracking arrangement 31 is able to be activated and deactivated. The output signals of blocks 31 and 32 control actuator arrangement 33. In the latter are included, for example, irreversible or reversible restraint systems, warning systems or subordinate controlling systems (see blocks 21, 22, 23 and 24, in FIG. 1).

1-12. (Canceled).

13. A method for influencing a first control system that regulates at least one of a position and an orientation of a motor vehicle with respect to a traffic lane, comprising:
detecting a potentially dangerous situation with respect to driving dynamics of the motor vehicle by determining whether regulating interventions influencing the driving dynamics are being performed by a vehicle dynamics control system present in the motor vehicle; and
deactivating the first control system when a danger of a collision of the motor vehicle with an obstacle in the traffic lane is detected, wherein the system is deactivated even if no potentially dangerous situation with respect to driving dynamics of the motor vehicle is detected, and wherein the first control system is an autonomous system to the motor vehicle.

14. The method of claim 13, wherein the first control system is deactivated when a clear indication is detected that a driver of the motor vehicle wants to leave the traffic lane.

15. A method for influencing a first control system that regulates at least one of a position and an orientation of a motor vehicle with respect to a traffic lane, comprising:
detecting a potentially dangerous situation with respect to driving dynamics of the motor vehicle by determining whether regulating interventions influencing the driving dynamics are being performed by a vehicle dynamics control system present in the motor vehicle; and
activating the first control system only when a potentially dangerous situation with respect to driving dynamics of the motor vehicle is detected, wherein the first control system is an autonomous system to the motor vehicle.

16. The method of claim 15, wherein the first control system is activated only if, in addition to the detection of a potentially dangerous situation with respect to driving dynamics of the motor vehicle, no danger of collision of the motor vehicle with an obstacle in the traffic lane is detected and no clear indication is detected that a driver of the motor vehicle wants to leave the traffic lane.

17. A method for influencing a first control system that regulates at least one of a position and an orientation of a motor vehicle with respect to a traffic lane, comprising:
detecting a potentially dangerous situation with respect to driving dynamics of the motor vehicle by determining whether regulating interventions influencing the driving dynamics are being performed by a vehicle dynamics control system present in the vehicle;
activating the first control system only if a potentially dangerous situation with respect to driving dynamics of the motor vehicle is detected; and
deactivating the first control system if a danger of a collision of the motor vehicle with an obstacle in the traffic lane is detected;
wherein the first control system is an autonomous system to the motor vehicle.

18. The method of claim 17, wherein:
the first control system is deactivated when one of: a) no potentially dangerous situation with respect to the driving dynamics of the motor vehicle is detected; and b) a clear indication is detected that a driver of the motor vehicle wants to leave the traffic lane; and
the first control system is activated only if, in addition to the detection of a potentially dangerous situation with respect to the driving dynamics of the motor vehicle, no danger of a collision of the motor vehicle with an obstacle in the traffic lane is detected and no clear indication is detected that the driver of the motor vehicle wants to leave the traffic lane.

19. The method of claim 13, wherein the detection of the danger of a collision with an obstacle is performed on the basis of at least one of variables describing a geometrical course of the traffic lane, variables describing a movement of the motor vehicle, and obstacles recorded by at least one of a video system and a radar system.

20. The method of claim 16, wherein the detection of the danger of a collision with an obstacle is performed on the basis of at least one of variables describing a geometrical course of the traffic lane, variables describing a movement of the motor vehicle, and obstacles recorded by at least one of a video system and a radar system.

21. The method of claim 17, wherein the detection of the danger of a collision with an obstacle is performed on the basis of at least one of variables describing a geometrical course of the traffic lane, variables describing a movement of the motor vehicle, and obstacles recorded by at least one of a video system and a radar system.

22. The method of claim 14, wherein the detection of the clear indication that the driver of the motor vehicle wishes to leave the traffic lane is performed on the basis of at least one of a direction indicator being operated by the driver and a steering wheel angular velocity exceeding a specified threshold value.

23. The method of claim 16, wherein the detection of the clear indication that the driver of the motor vehicle wishes to leave the traffic lane is performed on the basis of at least one of a direction indicator being operated by the driver and a steering wheel angular velocity exceeding a specified threshold value.

24. The method of claim 18, wherein the detection of the clear indication that the driver of the motor vehicle wishes to leave the traffic lane is performed on the basis of at least one of a direction indicator being operated by the driver and a steering wheel angular velocity exceeding a specified threshold value.

25. The method of claim 13, wherein the orientation of the motor vehicle with respect to the traffic lane is determined on the basis of an angle between the lane tangent and the longitudinal axis of the motor vehicle.

26. The method of claim 15, wherein the orientation of the motor vehicle with respect to the traffic lane is determined on the basis of an angle between the lane tangent and the longitudinal axis of the motor vehicle.

27. The method of claim 17, wherein the orientation of the motor vehicle with respect to the traffic lane is determined on the basis of an angle between the lane tangent and the longitudinal axis of the motor vehicle.

28. A device for influencing a first control system that regulates at least one of a position and an orientation of a motor vehicle with respect to a traffic lane, the first control system being an autonomous system to the vehicle, comprising:
an arrangement for activating and deactivating the first control system, wherein the first control system is deactivated when a danger of a collision of the motor vehicle with an obstacle in the traffic lane is detected, and wherein the first control system is activated only when a potentially dangerous situation with respect to driving dynamics of the motor vehicle is detected, the detection of the potentially dangerous situation with respect to the driving dynamics including a determination of whether regulating interventions influencing the driving dynamics are being performed by a vehicle dynamics control system present in the vehicle.
